(19) United States
(12) Patent Application Publication
(10) Pub. No.: US 2015/0178294 A1
(43) Pub. Date: Jun. 25, 2015

(54) RESOLVING CONTENT EDITING CONFLICTS ARISING FROM CONCURRENT DRAFTS

(71) Applicant: International Business Machines Corporation, Armonk, NY (US)

(72) Inventors: Nicholas A. Baldwin, Gladesville (AU); Mark C. Hampton, Carlton (AU); Stefan A. Hepper, San Jose, CA (US); Eric M. Morentin, Manly (AU)

(73) Assignee: International Business Machines Corporation, Armonk, NY (US)

(21) Appl. No.: 14/133,874

(22) Filed: Dec. 19, 2013

(51) Int. Cl. G06F 17/30; G06F 17/24

(52) U.S. Cl. CPC G06F 17/30082; G06F 17/24; G06F 17/3023

(57) ABSTRACT

Embodiments of the present invention provide a system, method, and program product to resolve editing conflicts in a content management system arising from concurrent drafts. A computing device receives notification of a first editing event and second editing event associated with a content item. The computing device determines a user-defined description of the first editing event and second editing event. The computing device determines a pre-defined editing policy associated with the first editing event and second editing event. The computing device deploys the first editing event and second editing event for servicing according to the determined user-defined description and the determined predefined policy, such that editing conflicts between the first and second editing events are reduced.

### BACKGROUND

The present disclosure relates generally to the field of content management systems, and more particularly to resolving editing conflicts in a content management system arising from concurrent drafts.

Content management systems (hereinafter “CMS”) are computer programs that allow publishing, editing, and modification of content on web sites as well as maintenance from a central interface. A CMS is often used to run websites containing blogs, news, and shopping. Such systems often provide procedures to manage workflow in a collaborative environment. A CMS is often used to run websites, for example, portals and blogs. FIG. 1 depicts an exemplary illustration of how a typical CMS functions. Briefly, users A, B, and C author content by creating and/or modifying content, such as text, media, and/or graphics, which is subsequently approved prior to being published by the CMS on the website using predetermined templates for target readers.

A CMS is of great value to an organization when various types of content are created concurrently by many users working across distributed teams. Typically, several users may have access to create and update content in a given section and/or part of a site and/or repository. In some systems, content can be locked to only allow one user to edit an item at a time. However, other systems recognize there is often a need to allow users to create multiple drafts or versions of a content item concurrently. When content is allowed to be edited concurrently there is an opportunity for conflicts to occur. Sometimes, even when concurrent updates are planned, it can be difficult to identify which draft takes precedence and when.

These conflicts are often hard to intercept and resolve. This situation is exacerbated when changes are made concurrently but submitted at different times, because some systems do not provide any tooling for managing conflicts and problems can occur as changes submitted last will simply overwrite earlier changes. Other systems provide tooling to address the issue, but still rely on manually comparing the changes and a user making a decision, but the content alone may not provide the information required to make the correct decision.

### SUMMARY

Embodiments of the present invention provide a system, method, and program product to resolve editing conflicts in a content management system arising from concurrent drafts. A computing device receives notification of a first editing event and second editing event associated with a content item. The computing device determines a user-defined description of the first editing event and second editing event. The computing device determines a pre-defined editing policy associated with the first editing event and second editing event. The computing device deploys the first editing event and second editing event for servicing according to the determined user-defined description and the determined predefined policy, such that editing conflicts between the first and second editing events are reduced.

### BRIEF DESCRIPTION OF THE SEVERAL VIEWS OF THE DRAWINGS

FIG. 1 depicts an exemplary illustration of how a typical content management system functions, in accordance with an illustrative embodiment of the present invention.

FIG. 2 depicts a block diagram illustrating components included in a computing device, in accordance with an embodiment of the present invention.

FIG. 3 depicts an exemplary table that reflects edits made to content that is included in content files, in accordance with an embodiment of the present invention.

FIG. 4 is a flowchart depicting operational steps of a program function, in accordance with an embodiment of the present invention.

FIG. 5 depicts a block diagram of components of the computing device, in accordance with an illustrative embodiment of the present invention.

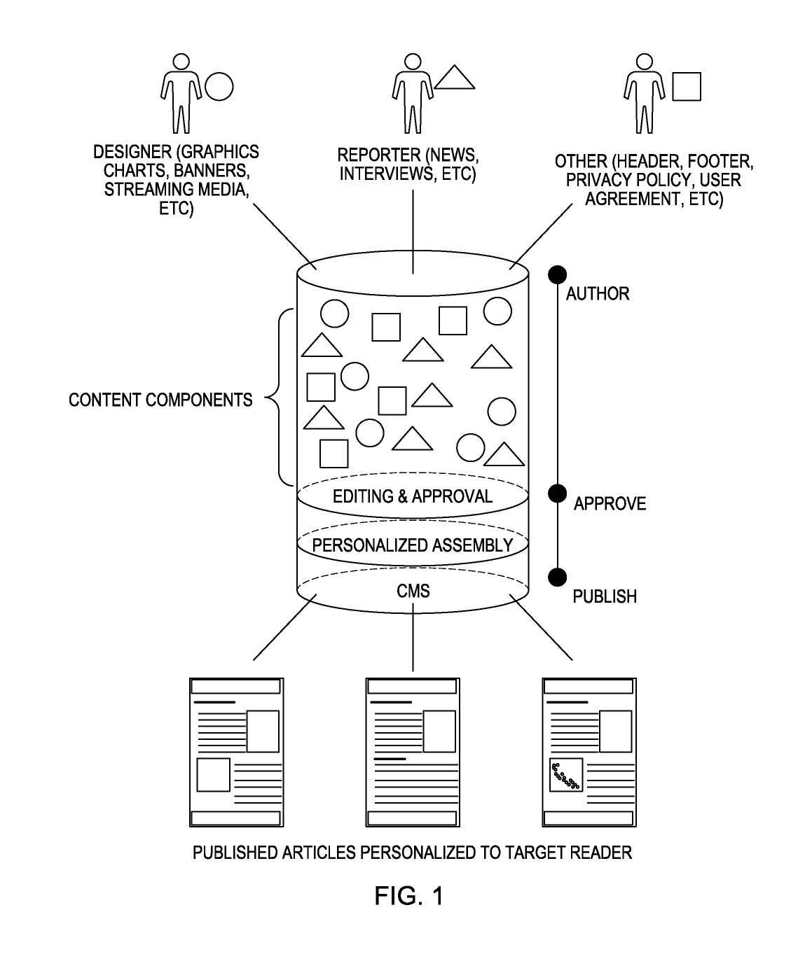

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon. As used herein, a user is an agent, either a human agent or software agent, who uses a computer or network service.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

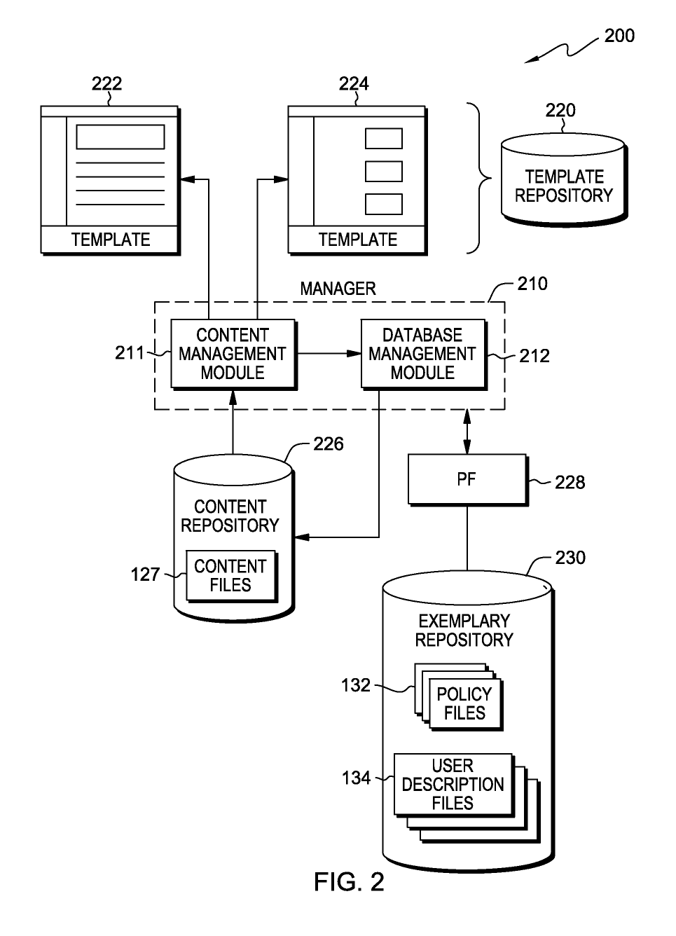

Embodiments of the present invention provide a system, method, and program product to track editing activities and automatically address editing conflicts using predetermined editing policies. Potential conflicts can be proactively managed by identifying the nature, purpose, and scheduling of changes being made by a user (hereinafter “editor”). Subsequently, potential conflicts are reduced by utilizing editing policies that describe how potential conflicts should be addressed. FIG. 2 depicts a block diagram illustrating computing device 200, in accordance with an embodiment of the present invention.

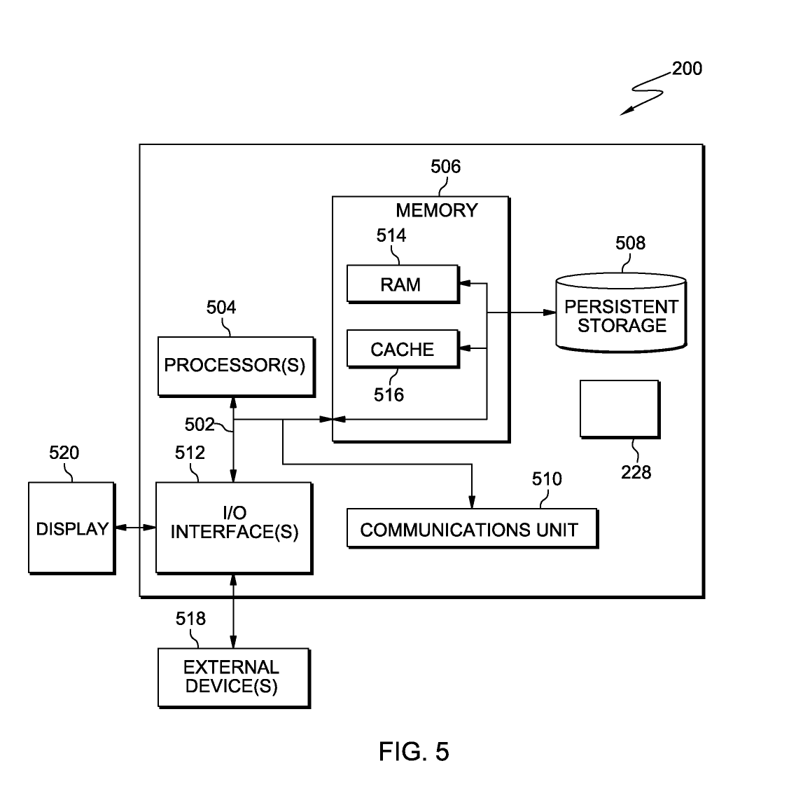

Computing device 200 is used to publish, edit, and/or modify content, in accordance with an embodiment of the present invention. Computing device 200 includes content manager 210, content repository 226, template repository 220, exemplary repository 230 and program function 228. Computing device 200 can receive edits from editors via a network, for example, a local area network (LAN), a wide area network (WAN) such as the Internet, or a combination of the two, and can include wired, wireless, or fiber optic connections. Computing device 200 may include internal and hardware components, as depicted and described in further detail with respect to FIG. 5. In general, computing device 200 can communicate using a network that utilizes any combination of connections and protocols that will support communications between computing device 200 and other computing devices.

Computing device 200 may be a laptop computer, tablet computer, netbook computer, personal computer (PC), a desktop computer, a personal digital assistant (PDA), a smart phone, or any programmable electronic device capable of communicating with another computing device via a network. Manager 210 is in communication with content repository 226, template repository 220, and program function 228, in accordance with an embodiment of the present invention. In an embodiment, manager 210 is content management software that allows a user to publish, edit, and/or modify text, graphics, and/or media (hereinafter “content”) from a central interface.

Manager 210 includes content management module 211 and database management module 212, in accordance with an embodiment of the present invention. Content management module 211 allows a user to publish, edit, and/or modify content included in content repository 226 (discussed below). Content management module 211 can instruct database management module 212, which is software can query content included in content repository 226, such as content files 127. Content management module 211 can publish information included in content files 127 using templates included in template repository 220, which include templates used to publish content, such as templates 222 and 224.

Exemplary repository 230 is in communication with program function 228, in accordance with an embodiment of the present invention. Exemplary repository 230 is an information repository that includes policy files 132 and user description files 134. User description files 134 include user-defined information that describes the nature of an edit made to content included in content files 127. Table 1 is an exemplary embodiment of information included in user description files 134.

TABLE 1

| | | Version | | | | Planned | |
|---|---|---|---|---|---|---|---|
| Item | Status | (based on) | Purpose | Description | Scope | Availability | Readiness |
| Visa Rewards | Draft | v12 | Revision | Update description - | 6 elements | 23 Jul. 2013 | Ready to |
| Description A | | | | new terms & rates | | | review |
| Visa Rewards | Draft | v11 | Minor | Spelling mistake | 1 element | 24 Jul. 2013 | Ready to |
| Description B | | | | fixes | | | review |
| Visa Rewards | Submitted | v12 | Major | Introducing new | All elements | 28 Aug. 2013 | Ready to |
| Description C | for approval | | | program | | | review |
| Visa Rewards | Draft | v11 | Minor | Minor grammatical | 1 element | 3 Sep. 2013 | Not ready |
| Description D | | | | edits | | | to review |

Table 1 includes several categories, item, status, version, description, scope, planned availability, and readiness. Item describes the name of the item draft, wherein the suffix indicates the version. Status reflects whether the state of an item draft is a draft or is published. Version reflects the version of the item the draft was based on. For example, if a currently published item is labeled v11 and it gets modified and published, a new label is generated for the modification in order to track it and rollback related modifications if needed. In addition, the version category allows one to track drafts created from v11. Hence, a draft's base version is available and may be incorporated in policies.

Purpose reflects the intended nature of the modification, for example, revision, minor change, and major change, and can be predefined by a user. In an embodiment, purpose is used as a label to differentiate revision, for example, by importance rather than the overall size of the modifications. The description category can be used for informational purposes. The scope category can be determined by program function 228, for example, by determining the number of fields modified by the user. The planned availability category reflects the scheduling (i.e. planned publication date). The readiness category reflects the preview/compare status of the draft. For example, minor edits can include spelling and/or grammar edits. Major edits can include stylistic, phrasing, revision of the content item's description, and/or structural edits. Revisions can include the replacement of a particular content item with a newer version of the content item.

Policy files 132 are included in exemplary repository 230, in accordance with an embodiment of the present invention. Policy files 132 includes predefined information reflective of one or more editing schemes that prioritizes the order with which concurrent editing events are serviced according to the nature, purpose, and scheduling of edits made, if at all. Policy files 132 include rules that reflect how program function 228 resolves potential editing conflicts. For example, there may be separate policies, such as a product descriptions policy, media release policy, promotion policy, and user guide policy. There may also be generic policies, for example, for content items authored by particular users. As an additional example, policies included in policy files 132 can dictate that the version of the item used as a base for the edits take precedence, then major changes take precedence over minor changes, then, finally, availability determines the schedule of primacy. Hence, policies may be generic, user-specific, and/or content item specific. Program function 228 is included in computing device 200 and is in communication with manager 210 and exemplary repository 230, in accordance with an embodiment of the present invention. Program function 228 is software that resolves potential editing conflicts by using predefined editing policies. Program function 228 can send instructions to manager 210.

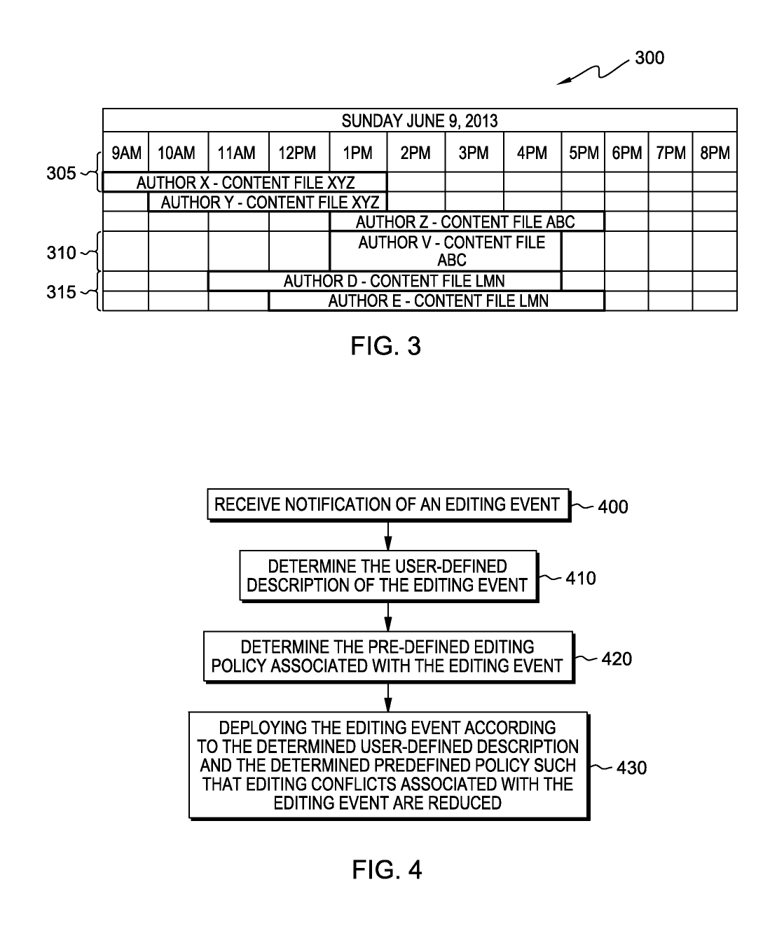

FIG. 3 depicts an exemplary table, generally 300, that reflects user-defined edits made to content that is included in content files 127, in accordance with an embodiment of the present invention. Specifically, table 300 illustrates the timing of editing events 305, 310, and 315 to content files XYZ, ABC, and LMN, respectively, which are included in content files 127. Editing events 305, 310, and 315 reflect the timing of edits to content file XYZ authors X and Y, edits to contents file ABC by authors Z and V, and edits to content file LMN by authors D and E, respectively. In an embodiment, program function 228 notifies all authors that are concurrently accessing and editing the same content included in content files 127.

To resolve the potential editing conflicts, program function 225 determines the priority that manager 210 publishes edits using predetermined editing policy information that is included policy files 132. For example, the editing policy associated with editing events 305, 310, and/or 315 may require that the version of the content file that was used as a base for the draft takes precedence, major changes take precedence over minor changes, and availability determines primacy. As per editing event 305, although both sets of edits were initiated at different times, both were submitted at roughly the same time; hence, if the edits were both minor, as determined by program function 228 using information included in user description files 134, program function 228 instructs manager 210 to allow an approver to compare and merge the edits prior to publishing them.

However, if, in addition, author X modified additional elements in content file XYZ than those by author Y, program function 228 instructs manager 210 to allow an approver to review the edits, using Author X's edits as the base, prior to publishing the edits. As per editing event 310, Author Z initiates a major edit of content file ABC prior to a minor edit thereof by Author V; however, Author V submits edits prior to Author Z. To address the potential editing conflict reflected in editing event 310, program function 225, using the editing policy information included in Table 1, instructs manager 210 to allow an approver to review the content modifications included in editing event 310, which use Author V's edits as the base and Author's Z's edits that do not conflict with those of Author V's.

As per editing event 315, Author D initiates and submits a major edit of content file LMN prior to the initiation and submission of a concurrent minor edit thereof by Author E, which may result in a potential editing conflict. In addition, Author D's edits are not scheduled for publication until an additional item in associated with content file LMN is ready for publication in four (4) weeks. To address the potential editing conflict reflected in editing event 315, program function 225, using the editing policy information included in Table 1, instructs manager 210 to allow an approver to review the content modifications included in editing event 310, which use Author D's edits as the base and includes Author E's non-conflicting edits. However, as there is a window of time between the schedule publishing of Author D's edits, program function 228 can instruct manager 210 to publish Author E's edits in the interim and then replace the published edits with Author D's edits when the appropriate time arrives.

Returning to Table 1 above, to address the potential conflicts that may result from the several different descriptions of “Credit Card Rewards”, program function 225, using policy files 132 (discussed above), determines that draft C has primacy over other drafts from Jul. 28, 2013 and draft A, which has an availability of Jul. 23, 2013, will have primacy until then. Program function 228 can also instruct manager 210 to allow draft A primacy over draft B, since draft A modified six (6) elements to draft B's one (1) element. However, program function 228 can instruct manager 210 to generate a notification informing Author A that there is a modification that needs review, if the modification included in draft B affect an element still in existence within draft A.

Optionally, program function 228 can instruct manager 210 to rebase draft B on version 12 prior to review and publication. Program function 228 can instruct manager 210 to not publish draft D and generate a notification for the author of draft C that there is a change to review, if the modifications made in draft D were made to an element in existence within draft C.

FIG. 4 is a flowchart depicting operational steps program function 228 for reducing editing conflicts that result from concurrent editing activities, in accordance with an embodiment of the present invention. Program function 228 receives notification of an editing event (step 400). Program function 228 determines the user-defined description of the editing event (step 410). Program function 228 determines the pre-defined editing policy associated with the editing event (step 420). Program function 228 deploys the editing event for servicing according to the determined user-defined description and the determined predefined policy, such that editing conflicts associated with the editing event are reduced (step 430).

FIG. 5 depicts a block diagram of components of computing device 200, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computing device 200 includes communications fabric 402, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Program function 228, manager 210, content repository 226, template repository 220, and exemplary repository 230 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Program function 228 and manager 210 may be downloaded to persistent storage 508 through communications unit 510.

I/O interface(s) 512 allows for input and output of data with other devices that may be connected to computing device 200. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., program function 228, can be stored on such portable computer-readable storage media and can be loaded onto persistent storage 508 via I/O interface(s) 512. I/O interface(s) 512 also connects to a display 520. Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1-7. (canceled)

8. A computer program product, the computer program product comprising a computer readable storage medium having program code embodied therewith, the program code executable by a processor to:
receive notification of a first editing event and second editing event associated with a content item;
determine a user-defined description of the first editing event and second editing event;
determine a pre-defined editing policy associated with the first editing event and second editing event;
deploy the first editing event and second editing event for servicing according to the determined user-defined description and the determined predefined policy, such that editing conflicts between the first and second editing events are reduced.

9. The computer program product of claim 8, further comprising: program code to generate a notification that the content item is undergoing concurrent editing events when the first editing event and second editing event occur concurrently.

10. The computer program product of claim 8, wherein the pre-defined editing policy dictates the order with which the first editing event and second editing event are serviced.

11. The computer program product of claim 8, wherein the user-defined description includes information reflective of a major edit, minor edit, and/or revision associated with the content item.

12. The computer program product of claim 11, wherein the major edit includes stylistic, phrasing, description, and/or structural edits.

13. The computer program product of claim 1, wherein the minor edit includes spelling and/or grammar corrections.

14. The computer program product of claim 8, wherein the pre-defined editing policy is generic, user specific, and/or content item specific.

15. A computer system:
one or more computer processors;
one or more computer-readable storage media;
program instructions stored on the computer-readable storage media for execution by at least one of the one or more processors, the program instructions comprising:
program instructions to
receive notification of a first editing event and second editing event associated with a content item;
determine a user-defined description of the first editing event and second editing event;
determine a pre-defined editing policy associated with the first editing event and second editing event;
deploy the first editing event and second editing event for servicing according to the determined user-defined description and the determined predefined policy, such that editing conflicts between the first and second editing events are reduced.

16. The computer system of claim 15, program code to generate a notification that the content item is undergoing concurrent editing events when the first editing event and second editing event occur concurrently.

17. The computer system of claim 15, wherein
the pre-defined editing policy dictates the order with which the first editing event and second editing event are serviced; and/or
the pre-defined editing policy is generic, user specific, and/or content item specific.

18. The computer system of claim 15, wherein the user-defined description includes information reflective of a major edit, minor edit, and/or revision associated with the content item.

19. The computer system of claim 18, wherein the major edit includes stylistic, phrasing, description, and/or structural edits.

20. The computer system of claim 18, wherein the minor edit includes spelling and/or grammar corrections.
